(19) United States
(12) Patent Application Publication
(10) Pub. No.: US 2026/0097617 A1
(43) Pub. Date: Apr. 9, 2026

(54) Kit and Method for Converting a Manual Trailer Tongue Jack Assembly to Power Drill Drive

(71) Applicant: Dutton-Lainson Company, Hastings, NE (US)

(72) Inventors: Walker L. Stuhr, Hastings, NE (US); Zane A. Norton, Hastings, NE (US)

(21) Appl. No.: 19/237,169

(22) Filed: Jun. 13, 2025

Related U.S. Application Data
(63) Continuation-in-part of application No. 18/790,299, filed on Jul. 31, 2024.

(51) Int. Cl. B60D 1/66; B60S 9/18

(52) U.S. Cl. CPC B60D 1/665; B60S 9/18

(57) ABSTRACT

A kit adapted for converting a manual jack assembly to power drill drive includes a power drill drive unit, including (a) a first drive shaft adapted for connecting the power drill drive unit to an original output gear of the manual jack assembly, (b) a second drive shaft including a torque limiter, and (c) a gear reduction section connecting the second drive shaft to the first drive shaft. The kit is useful in a method of converting a manual jack assembly to power drill drive. The method includes removing an original output gear of the manual jack assembly from an original drive shaft of the manual jack assembly, replacing the original drive shaft of the manual jack assembly with a first drive shaft adapted to connect a power drill drive unit to the manual jack assembly, and connecting the first drive shaft to the original output gear.

### RELATED APPLICATIONS

This document is a continuation-in-part (CIP) of U.S. patent application Ser. No. 18/790,299, filed on Jul. 31, 2024, the full disclosure of which is incorporated herein by reference.

### TECHNICAL FIELD

This document relates generally to a kit and method for converting a manual jack assembly to allow for both manual direct drive and torque limited power drill drive.

### BACKGROUND

Trailers for campers, boats and the like are equipped with tongue jacks that are adapted to support the tongue of the trailer when the trailer is disconnected from a towing vehicle. By adjusting the height of the tongue jack it is possible to raise and lower the tongue at the front end of the trailer thereby allowing one to level the trailer or even raise the trailer coupler into a position where it may later be conveniently lowered onto the hitch ball of a towing vehicle.

This document relates to a kit and method for converting a manual jack assembly to allow for both manual direct drive, with a crank handle, or torque limited power drill drive. Cordless power drills are affordable and a large segment of the trailer using population already has access to one. Thus, the jack assembly advantageously allows for an operator to have the convenience of power jack drive without the costs associated with a jack having a built in drive motor or the headaches of having to find a power source for that motor.

The kit and method are particularly useful on trailers, e.g., watercraft and boat trailers. When launching or recovering a boat, such trailers are often backed into the water far enough to at least partially submerge the jack assembly which could have a detrimental effect on a built-in motor drive. This problem is avoided when using a power drill to power the jack assembly.

### SUMMARY

In accordance with the purposes and benefits set forth herein, a kit, adapted for converting a manual jack assembly to power drill drive, comprises, consists of or consists essentially of a power drill drive unit including a first drive shaft adapted for connecting the power drill drive unit to an original output gear of the manual jack assembly. The power drill drive unit also includes a second drive shaft, including a torque limiter. A gear reduction section connects the second drive shaft to the first drive shaft whereby the power drill drive unit is connected to the manual jack assembly to convert the manual jack assembly to power drill drive.

In at least some of the many possible embodiments, the first drive shaft includes a first input end adapted to engage a handle and the second drive shaft includes a second input end adapted to engage a power drill. The original output gear may be carried on the first drive shaft. The gear reduction section may include a compound gear carried on an intermediate shaft.

The torque limiter may be a slip clutch. The torque limiter and gear reduction section may be contained in a gear box housing. In some embodiments, the first and second drive shafts extend through the gear box housing and the first drive shaft further extends into the body of the manual jack assembly wherein the original output gear is carried on the first drive shaft.

In accordance with an additional aspect, a method for converting a manual jack assembly to power drill drive, comprises, consists of or consists essentially of: (a) removing an original output gear from an original drive shaft of the manual jack assembly and (b) connecting a power drill drive unit to the manual jack assembly by means of a first drive shaft, which replaces the original drive shaft and is adapted for connecting the power drill drive unit to the original output gear.

In accordance with yet another aspect, a method of converting a manual jack assembly to power drill drive, comprises, consists of or consists essentially of: (a) removing an original output gear of the manual jack assembly from an original drive shaft of the manual jack assembly; (b) replacing the original drive shaft of the manual jack assembly with a first drive shaft adapted to connect a power drill drive unit to the manual jack assembly, and (c) connecting the first drive shaft to the original output gear.

The removing of the original output gear from the original drive shaft may include withdrawing the original drive shaft from the manual jack assembly during the removing of the original output gear from the original drive shaft.

The method may also include removing a cap from the manual jack assembly to expose the original output gear and the original drive shaft before the removing of the original output gear and the original drive shaft from the manual jack assembly. The removing of the original output gear may include removing a roll pin or a key holding the original output gear to the original drive shaft.

The method may further include positioning the original output gear on the first drive shaft as the first drive shaft is being inserted in the manual jack assembly. The method may further include locking the original output gear to the first driveshaft by inserting the roll pin or a key. The method may further include driving the manual jack assembly with a power drill connected to the power drill drive unit.

Where the power drill drive unit includes the first driveshaft and a second drive shaft, the method may further comprise connecting the handle to the first drive shaft to operate the manual jack assembly manually or connecting a power drill to the second driveshaft to operate the manual jack assembly with the power drill.

The method may further include providing a torque limiter on the second driveshaft. In at least some embodiments, the method further includes driving the manual jack assembly with a power drill connected to the power drill drive unit. Where the power drill drive unit includes the first driveshaft and a second drive shaft, the method may further comprise connecting a handle to the first drive shaft to operate the manual jack assembly manually or connecting a power drill to the second driveshaft to operate the manual jack assembly with the power drill.

In accordance with yet another aspect, a system for converting a wide range of manual jack assemblies to allow for both manual direct drive and torque limited power drill drive, the system comprises, consists of or consists essentially of: (a) a universal power drill drive unit, and (b) a plurality of different drive shafts wherein the plurality of different drive shafts are adapted to connect the universal drill drive unit to different makes and models of manual jack assemblies.

In the following description, there are shown and described several different embodiments of the kit, system and related method of converting a manual jack to power drill drive. As it should be realized, the kit, the system and the method are capable of other, different embodiments and their several details are capable of modification in various, obvious aspects all without departing from the kit, the system and the method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate certain aspects of the kit, the system and the method and together with the description serve to explain certain principles thereof. A person of ordinary skill in the art will readily recognize from the following discussion that alternative embodiments of the kit, the system and the method may be employed without departing from the principles described below.

FIG. 1 is a perspective view of a kit for converting a manual jack assembly to allow for both manual direct drive and torque limited power drill drive.

FIGS. 2A-2I are a series of views illustrating the new method for converting a manual jack assembly to allow for both manual direct drive and torque limited power drill drive.

FIG. 3A is perspective view illustrating a first possible bracket embodiment adapted for securing the drill drive unit to, a square tube trailer tongue jack assembly.

FIG. 3B is perspective view illustrating a second possible bracket embodiment adapted for securing the drill drive unit to, a round tube trailer tongue jack assembly.

FIG. 4 is a partially cut away and cross-sectioned view of a converted tongue jack assembly connected to a removable crank handle for manual operation by turning of the crank handle;

FIG. 5 is a detailed, exploded and perspective view of the drive train of the converted jack assembly, including the gear reduction section thereof;

FIG. 6 is a detailed, exploded and perspective view of the slip clutch and second drive shaft on which the slip clutch is carried; and

FIG. 7 is a view similar to FIG. 4 but illustrating operation of the converted jack assembly with a battery powered drill instead of the manual crank handle.

FIG. 8 is a perspective view of a new system for converting a wide range of manual jack assemblies to allow for both manual direct drive and torque limited power drill drive.

Reference will now be made in detail to the present embodiments of the kit, the system and related methods, examples of which are illustrated in the accompanying drawing figures, wherein like numerals are used to represent like elements.

### DETAILED DESCRIPTION

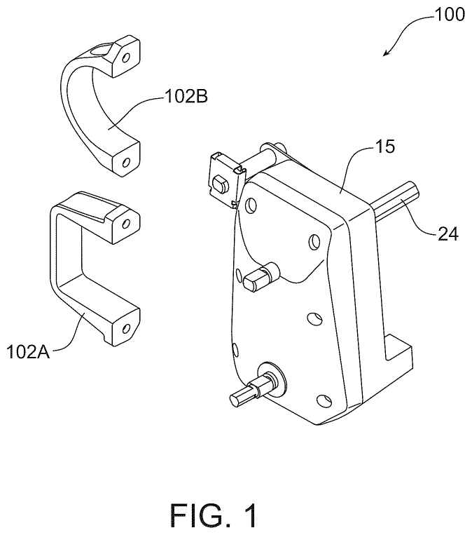

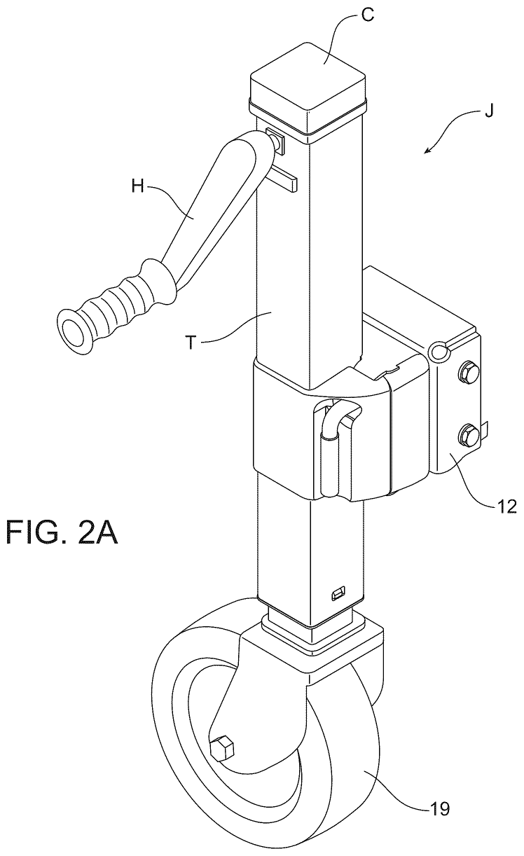

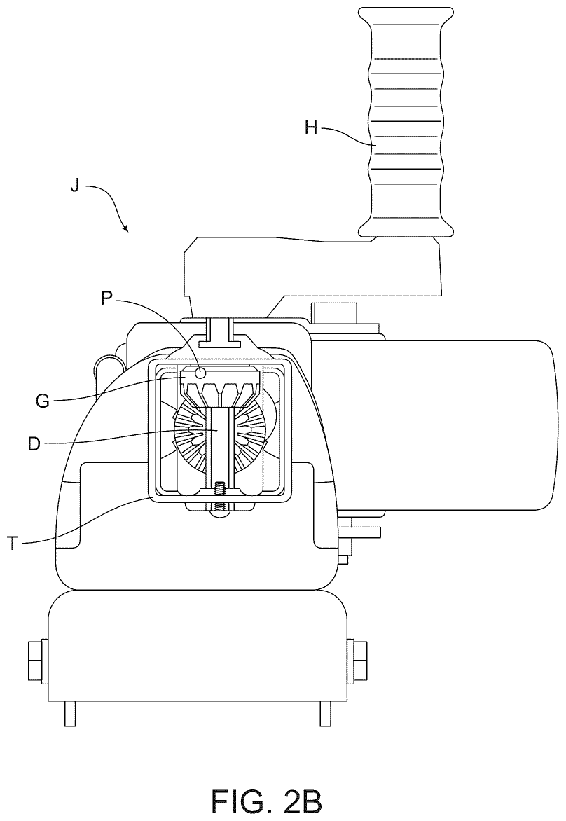

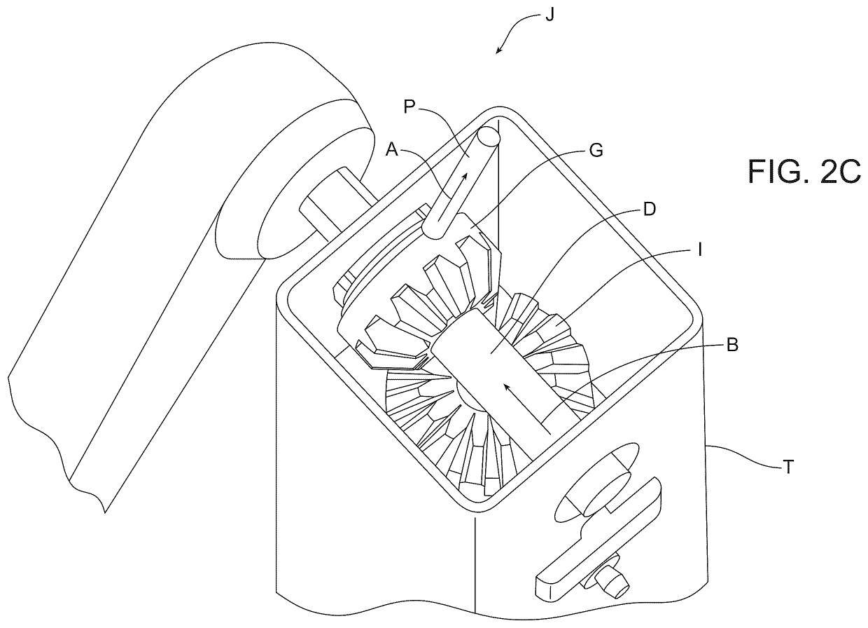

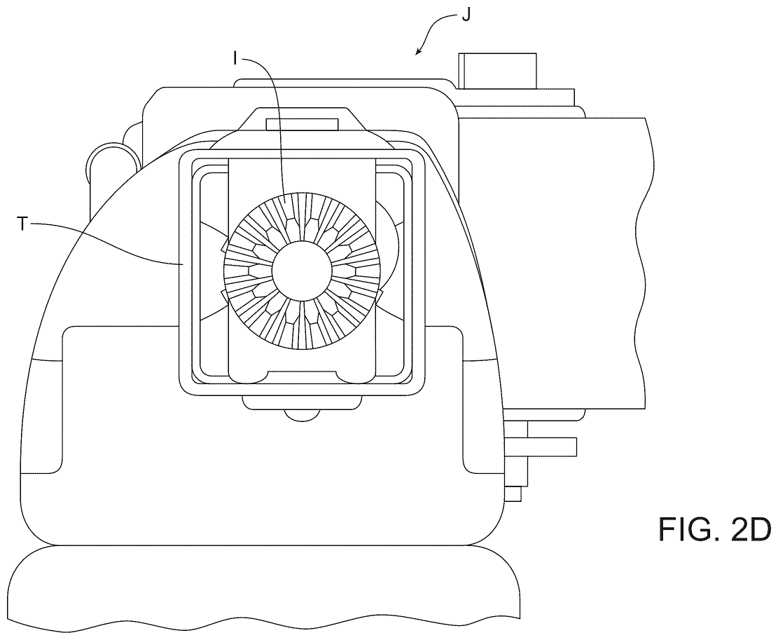

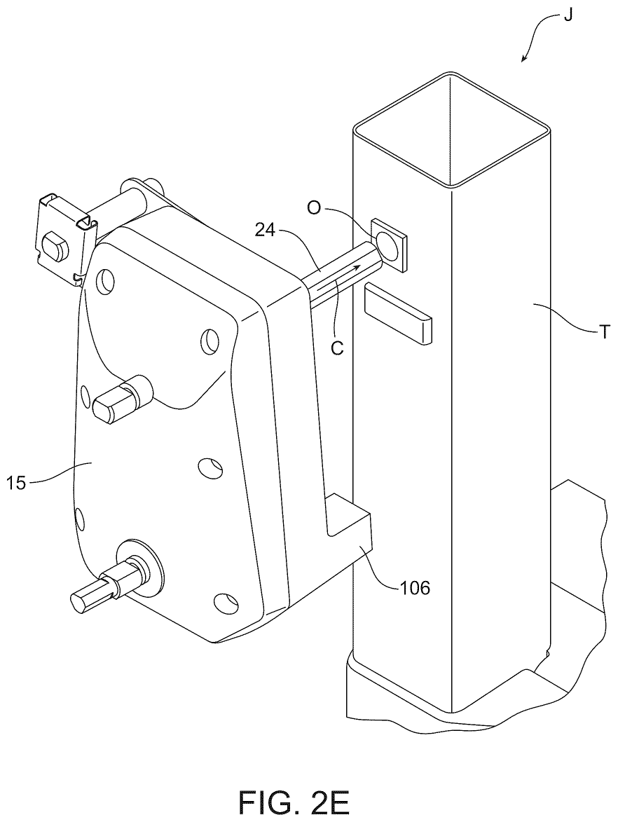

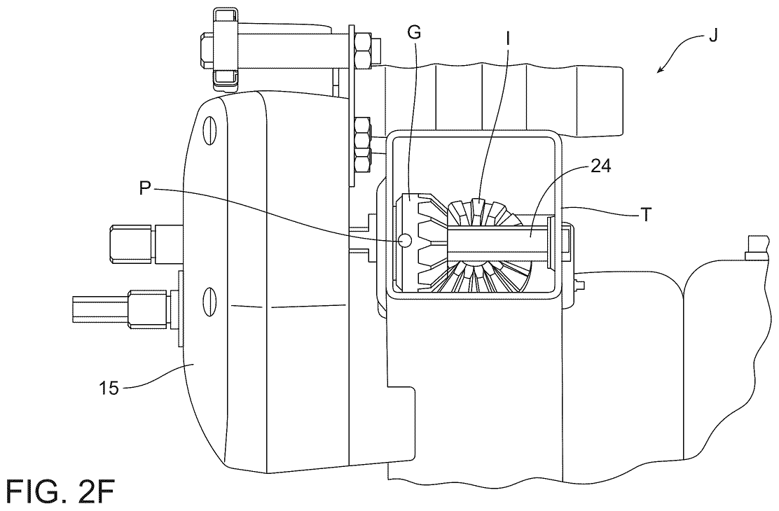

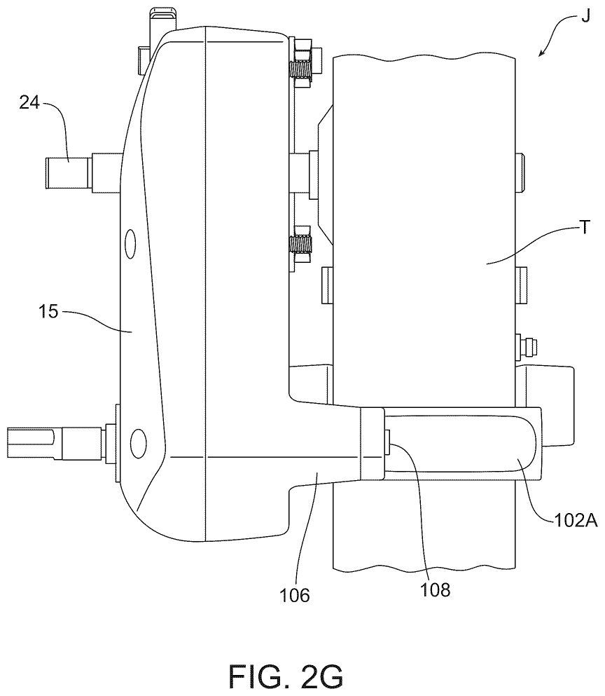

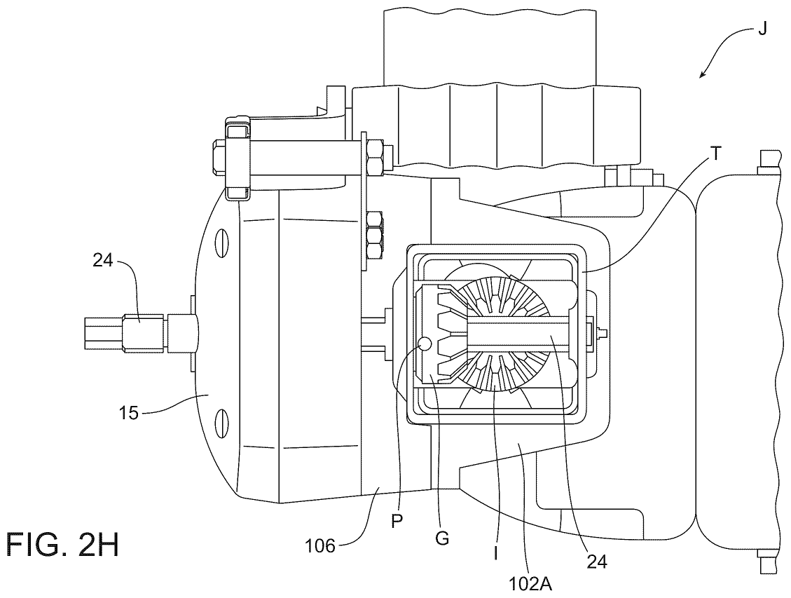

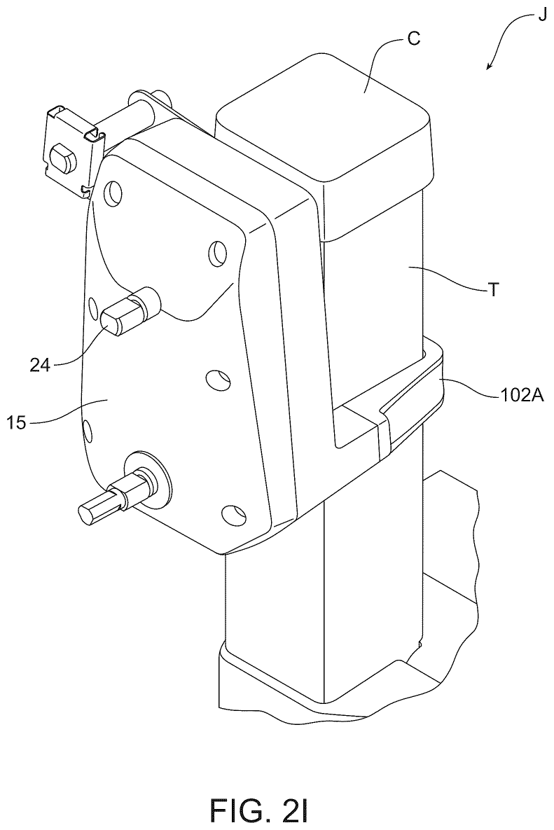

Reference is now made to FIG. 1 which illustrates the new and improved kit 100 adapted for converting a manual jack assembly J to allow for both manual direct drive and torque limited power drill drive. As shown in FIG. 1, the kit 100 includes a power drill drive unit 15 having a first drive shaft 24 adapted for connecting the power drill drive unit to an original output gear G of the manual jack assembly J. The kit 100 also includes one of two different mounting brackets 102A, 102B, described in greater detail below. The jack assembly J of the type being converted (see FIG. 2A) may be mounted by a mounting assembly 12 to a tongue of a camper trailer, boat trailer or the like (not shown).

FIGS. 2A-2I are a series of views illustrating the related method for using the kit 100 to convert a manual jack assembly J to allow for both manual direct drive and torque limited power drill drive. FIG. 2A illustrates the manual jack assembly J prior to conversion. The first step of the method involves removing the original output gear G and original drive shaft D from the manual jack assembly J.

As illustrated in FIGS. 2A and 2B this may be accomplished by removing the cap C from the manual jack assembly J to expose the original drive shaft D and the original output gear G within the tube T. Next, as illustrated in FIGS. 2C and 2D, the original drive shaft D and original output gear G are removed. For some manual jack assemblies J, this may be accomplished by first removing with a punch (not shown) a roll pin P holding the original gear G to the original drive shaft D. See action arrow A. For other jack assemblies J, it is necessary to remove a key (not shown) holding the original gear G to the original drive shaft D in a manner known in the art. For still other jack assemblies, it will be necessary to remove a snap ring or e-clip in a manner known in the art. Once the original output gear G is disconnected from the original drive shaft D, one slides the original drive shaft in the direction of action arrow B using the handle H. As this is done, the original output gear G, and any associated washer, slides off of the drive shaft D. FIG. 2D shows the original output gear G and original drive shaft D removed, exposing the input gear I.

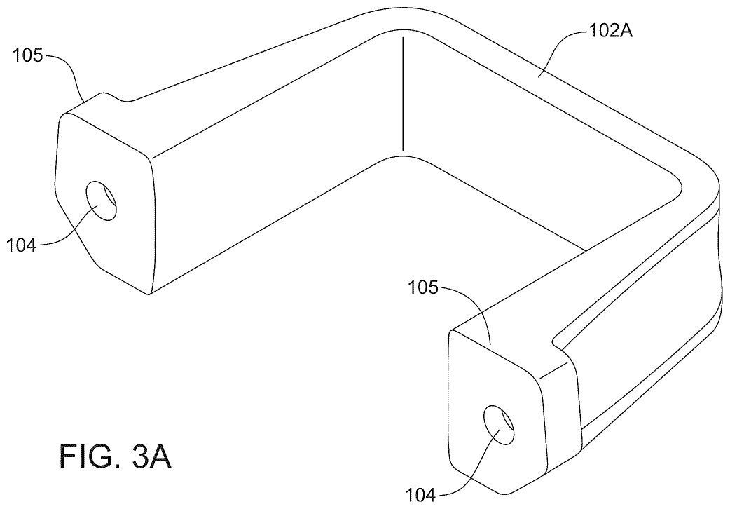

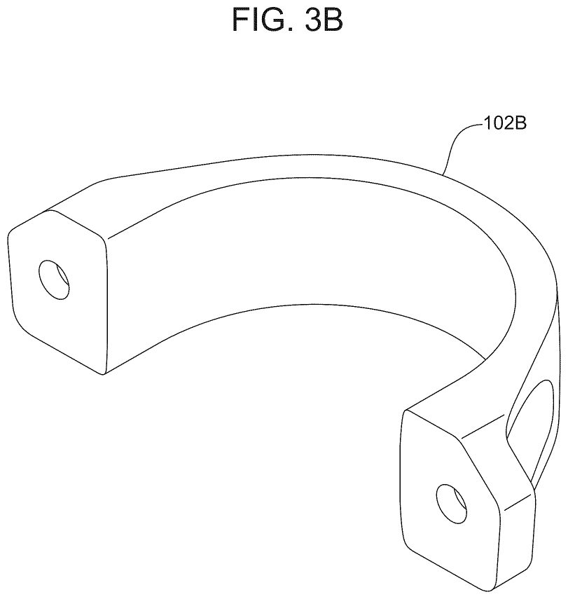

Next, as illustrated in FIGS. 2E and 2F, the original output gear G is positioned on the first drive shaft 24 as the first drive shaft is being inserted through the drive shaft opening O in the tube T of the jack assembly J (note action arrow C). The original output gear G is then pinned or keyed to the drive shaft 24 in a manner known in the art using the same connection system used to connect the original output gear to the original drive shaft D. Note, for example, the pin P shown in FIGS. 2C and 2F. This may be followed by securing the power drill drive unit 15 to the jack assembly J using the bracket 102A illustrated in FIG. 3A. More specifically screw fasteners 108 (received in the apertures 104 at each end 105 of the bracket 102A) are tightened in cooperating threaded apertures in the drill drive unit housing 106 to complete the connection (see FIGS. 2G and 2H). The cap C is then reseated on the top of the tube T to complete the conversion process (see FIG. 2I). Where the manual jack being converted is a round tube jack of a type known in the art, the drive unit housing 106 is adapted to receive the round tube, rather than the square tube, and the other bracket 102B (see FIG. 3B) is used to complete the process of securing the power drill drive unit to the round tube of the jack.

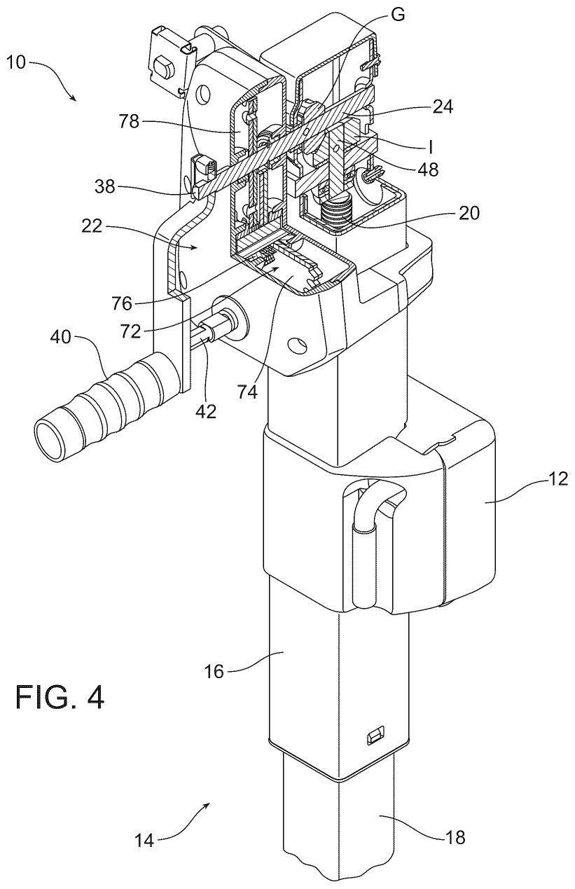

As best illustrated in FIGS. 4-7, the converted jack assembly 10 includes a telescoping body generally designated by reference number 14. As is known in the art, the telescoping body 14 includes an outer tube 16 and an inner tube 18. The inner tube 18 is supported for telescoping movement within and relative to the outer tube 16. In the illustrated embodiment, the outer tube 16 and the inner tube 18 are made from hollow square steel tubing although other constructions are possible. As is known in the art, the inner tube 18 includes a ground engaging foot or wheel 19 on the lowermost end thereof. (see FIG. 2A).

The converted jack assembly 10 also includes a jackscrew 20 that is operatively connected to the inner tube 18 by engaging a jack nut (not shown) fixed to the inner tube 18 in a manner known in the art. The jackscrew 20 is adapted to extend or retract the telescoping body 14; that is, extend the inner tube 18 downward from the outer tube 16 or retract the inner tube upward into the outer tube to respectively raise or lower the tongue of the trailer to which the jack assembly 10 is mounted. Further, the converted jack assembly 10 includes a drive train, generally designated by reference numeral 22, that is shown in FIGS. 4-7. The drive train 22 is adapted to drive the jackscrew 20 and control operation of the jack assembly 10.

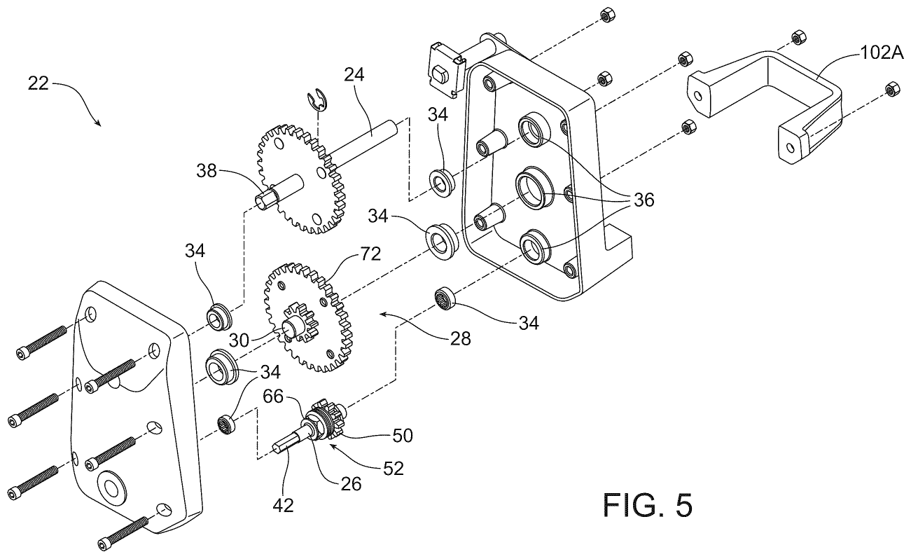

More particularly, as best illustrated in FIGS. 4 and 5, the drive train 22 includes the first drive shaft 24, a second drive shaft 26 and a gear reduction section generally designated by reference numeral 28. The first drive shaft 24, the second drive shaft 26 and the intermediate shaft 30 of the gear reduction section 28 are all supported for relative rotation by the drive unit or gear box housing 106 in a manner known in the art. Note particularly the bearings 34 and the bearing receivers 36 built into or otherwise supported by the gear box housing 106 supported by the telescoping body 14.

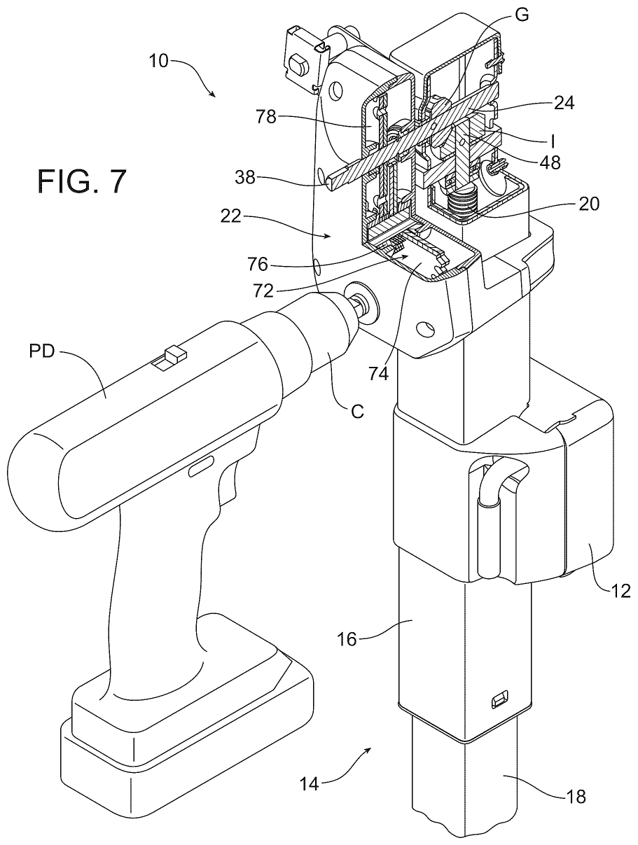

As shown in FIG. 4, the first drive shaft 24 includes a first input end 38 adapted to receive or engage hand crank 40, and extends through the gear box housing 106 and at least partially through the telescoping body 14. As illustrated, the hand crank 40 may be a removable, manual hand crank. The second drive shaft 26 includes a second input end 42 adapted to be engaged by a chuck C of a battery powered power drill PD (see FIG. 7) and is otherwise contained within the gear box 106. The original output gear G is carried on and fixed to the first drive shaft 24 a distance from the first input end 38 and within the telescoping body 14. The output gear G meshes with the input gear I fixed to an upper end 48 of the jackscrew 20 also within the telescoping body 14.

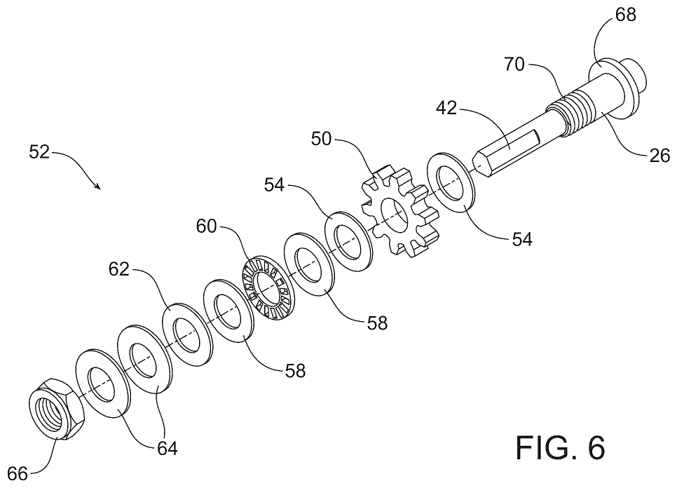

As best illustrated in FIGS. 5 and 6, the drive train 22 also includes a driver 50 and a torque limiter 52 between the second input end 42 of the second drive shaft 26 and the driver. As shown in detail in FIG. 6, the torque limiter 52 in the illustrated embodiment is a slip clutch. The torque limiter/slip clutch 52 includes two clutch pads 54 sandwiching the driver 50, and two thrust bearing races 58 sandwiching a thrust bearing 60. The described torque limiter/slip clutch 52 also includes a flat washer 62, two Belleville washers 64, and a lock nut 66. All of these components 54, 58, 60, 62, and 64 are positioned over the second input end 42 of the second drive shaft 26 in the order shown in FIG. 3 and tightened against a fixed stop 68 of the second drive shaft through engagement with and tightening of the lock nut 66 onto a threaded portion 70 of the second drive shaft. Of course, other variations of slip clutches may be utilized.

In the illustrated embodiment, the gear reduction section 28 includes a compound gear 72 carried on the intermediate shaft 30. The compound gear 72 includes a driven gear 74 in engagement with the driver 50, keyed or otherwise fixed to the second drive shaft 26, and a driver gear 76 in engagement with a driven wheel 78, keyed or otherwise fixed to the first drive shaft 24.

The trailer tongue jack assembly 10 is useful in a method of driving the jackscrew 20 with either (a) a manual crank handle 40 attached to the first input end 38 of the first drive shaft 24 as shown in FIG. 1, or (b) a power drill PD attached to the second input end 42 of the second drive shaft 26 as shown in FIG. 4. When operating the jack assembly 10 using the power drill PD, the torque limiter/slip clutch 52 on the second drive shaft 26 prevents the operator from being subjected to high torque forces created by the jackscrew 20 bottoming out, or if the jack assembly 10 is overloaded. The gear reduction provided by the gear reduction section 28 allows for proper operation of the torque limiter/slip clutch 52. The gear reduction section 28 also provides a more controlled speed when using a power drill PD while reducing the amount of torque needed from the drill to operate the jack assembly 10. Thus, the capacity of the jack assembly 10 is not reduced when using the power drill PD.

One of the issues with attaching a power drill PD directly to a jack assembly without any gear reduction is having enough torque to operate the jack in a typical or customary manner. Otherwise, a rated capacity of the jack would have to be reduced. Advantageously, that is not the case with the disclosed jack assembly 10.

In contrast, when operating the jack assembly 10 manually, the removable manual crank handle 40 is connected to the first drive shaft 24 above the gear reduction section 28 so as to provide direct drive through the first drive shaft 24 and associated output gear G to the input gear I fixed to the jackscrew 20. Thus, the torque limiter/slip clutch 52 is bypassed when using the manual crank handle 40. As a result, the operating speed is the same as for a typical manual jack.

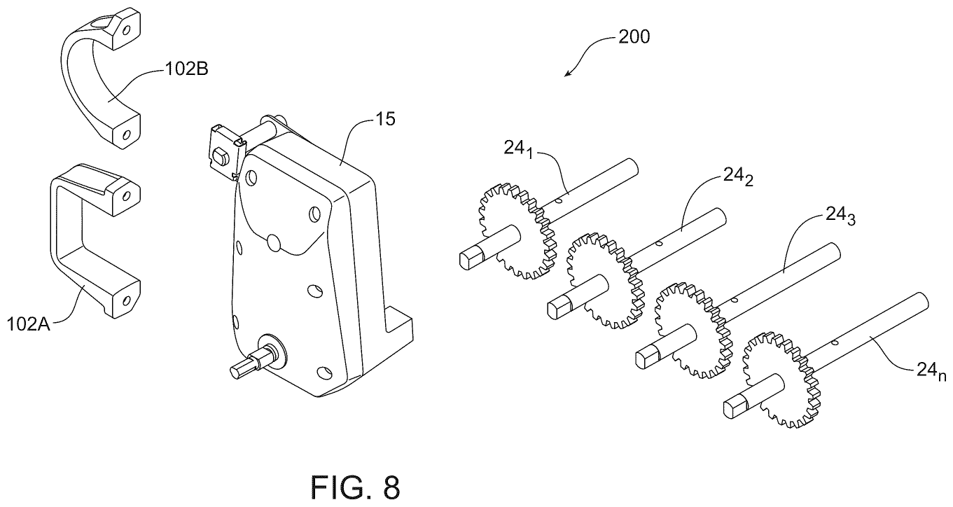

As should be appreciated from the above description, it is possible for one power drill drive unit 15 of universal design to be used to convert a wide range of manual jack assemblies to allow for both manual direct drive and torque limited power drill drive. Toward this end, a system 200 is provided for converting a wide range of manual jack assemblies to allow for both manual direct drive and torque limited power drill drive. As shown in FIG. 8, the system includes a universal power drill drive unit 15 and a plurality of different drive shafts 24₁-24ₙ wherein the plurality of different drive shafts are adapted to connect the universal drill drive unit to different makes and models of manual jack assemblies through the original output gear G of those jack assemblies in the manner described above.

Each shaft 24₁-24ₙ is adapted for connection to the power drill drive unit 15 and the particular make and model of manual jack assembly to be converted. A customer can then select the first drive shaft 24₁-24ₙ needed to connect the universal power drill drive unit 15 to the particular manual jack assembly J the customer is seeking to convert. A simple, customer friendly process representing a significant advance in the art. The universal drive unit 15, equipped with the customer selected first drive shaft 24, can then be shipped as one unit from the supplier/manufacturer to the customer. The customer can then complete the simple do-it-yourself conversion as shown in FIGS. 2A-2I.

Each of the following terms written in singular grammatical form: “a”, “an”, and “the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise. For example, the phrase: “a washer”, as used herein, may also refer to, and encompass, a plurality of washers.

Each of the following terms: “includes”, “including”, “has”, “having”, “comprises”, and “comprising”, and, their linguistic / grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

The phrase “consisting of”, as used herein, is closed-ended and excludes any element, step, or ingredient not specifically mentioned. The phrase “consisting essentially of”, as used herein, is a semi-closed term indicating that an item is limited to the components specified and those that do not materially affect the basic and novel characteristic(s) of what is specified.

Terms of approximation, such as the terms about, substantially, approximately, etc., as used herein, refers to ±10% of the stated numerical value.

Although the jack assembly 10 and related methods disclosed herein have been illustratively described and presented by way of specific exemplary embodiments, and examples thereof, it is evident that many alternatives, modifications, or/and variations, thereof, will be apparent to those skilled in the art. Accordingly, it is intended that all such alternatives, modifications, or/and variations, fall within the spirit of, and are encompassed by, the broad scope of the appended claims.

What is claimed is:

1. A kit adapted for converting a manual jack assembly to power drill drive, the kit comprising:
a power drill drive unit including (a) a first drive shaft adapted for connecting the power drill drive unit to an original output gear of the manual jack assembly, (b) a second drive shaft including a torque limiter, and (c) a gear reduction section connecting the second drive shaft to the first drive shaft whereby the power drill drive unit is connected to the manual jack assembly to convert the manual jack assembly to power drill drive.

2. The kit of claim 1, wherein the-first drive shaft includes a first input end adapted to engage a handle and the second drive shaft includes a second input end adapted to engage a power drill.

3. The kit of claim 2, wherein the original output gear is carried on the first drive shaft.

4. The kit of claim 3, wherein the gear reduction section includes a compound gear carried on an intermediate shaft.

5. The kit of claim 4, wherein the torque limiter is a slip clutch.

6. The kit of claim 1, wherein the torque limiter and gear reduction section are contained in a gear box housing.

7. The kit of claim 6, wherein the first and second drive shafts extend through the gear box housing and the first drive shaft further extends into the body of the manual jack assembly wherein the original output gear is carried on the first drive shaft.

8. A method for converting an manual jack assembly to power drill drive, comprising:
removing an original output gear from an original drive shaft of the manual jack assembly; and
connecting a power drill drive unit to the manual jack assembly by means of a first drive shaft adapted for connecting the power drill drive unit to the original output gear.

9. A method of converting a manual jack assembly to power drill drive, comprising:
removing an original output gear of the manual jack assembly from an original drive shaft of the manual jack assembly;
replacing the original drive shaft of the manual jack assembly with a first drive shaft adapted to connect a power drill drive unit to the manual jack assembly; and
connecting the first drive shaft to the original output gear.

10. The method of claim 9, wherein the removing of the original output gear from the original drive shaft includes-withdrawing the original drive shaft from the manual jack assembly during the removing of the original output gear from the original drive shaft.

11. The method of claim 10, including removing a cap from the manual jack assembly to expose the original output gear and the original drive shaft before the removing of the original output gear and the original drive shaft from the manual jack assembly.

12. The method of claim 11, wherein removing the original output gear includes removing a roll pin or a key holding the original output gear to the original drive shaft.

13. The method of claim 12, further including positioning the original output gear on the first drive shaft as the first drive shaft is being inserted in the manual jack assembly.

14. The method of claim 13, further including locking the original output gear to the first driveshaft by inserting the roll pin or a key.

15. The method of claim 14, further including driving the manual jack assembly with a power drill connected to the power drill drive unit.

16. The method of claim 15, wherein the power drill drive unit includes the first driveshaft and a second drive shaft, and the method further comprises connecting the handle to the first drive shaft to operate the manual jack assembly manually or connecting a power drill to the second driveshaft to operate the manual jack assembly with the power drill.

17. The method of claim 16, further including providing a torque limiter on the second driveshaft.

18. The method of claim 9, further including driving the manual jack assembly with a power drill connected to the power drill drive unit.

19. The method of claim 9, wherein the power drill drive unit includes the first driveshaft and a second drive shaft, and the method further comprises connecting a handle to the first drive shaft to operate the manual jack assembly manually or connecting a power drill to the second driveshaft to operate the manual jack assembly with the power drill.

20. A system for converting a wide range of manual jack assemblies to allow for both manual direct drive and torque limited power drill drive, the system comprising:
a universal power drill drive unit; and
a plurality of different drive shafts wherein the plurality of different drive shafts are adapted to connect the universal drill drive unit to different makes and models of manual jack assemblies.
